(19) United States
(12) Patent Application Publication
(10) Pub. No.: US 2010/0306177 A1
(43) Pub. Date: Dec. 2, 2010

(54) HOST OPERATING SYSTEM INDEPENDENT STORAGE-RELATED REMOTE ACCESS AND OPERATIONS

(76) Inventors: Hormuzd M. Khosravi, Portland, OR (US); Yasser Rasheed, Beaverton, OR (US); Dominic Fulginiti, Beaverton, OR (US); Tim Abels, Beaverton, OR (US); Divya Naidu Kolar Sunder, Beaverton, OR (US); Sudheer Mogilappagari, Hillsboro, OR (US)

Correspondence Address: The Law Offices of Christopher K. Gagne;c/o CPA Global, B.O. Box 52050, Minneapolis, MN, 55402, US

(21) Appl. No.: 12/475,216

(22) Filed: May 29, 2009

(51) Int. Cl. G06F 12/14; G06F 12/00; G06F 21/00; G06F 12/16

(52) U.S. Cl. 707/674; 726/26; 726/4; 711/E12.001; 711/E12.091; 711/E12.103; 707/803; 707/640; 707/805; 707/822; 707/770

(57) ABSTRACT

An embodiment may include circuitry that may be comprised in a host that may execute an operating system and/or in a server. The circuitry may generate, at least in part, and/or receive, at least in part, at least one request to initiate, at least in part, at least one operation at the host. The least one operation may facilitate, at least in part, examination remotely from the host of information stored at the host. The at least one operation may be performed independently from the operating system and also may be performed at least in part by the circuitry. The examination may facilitate, at least in part, remotely from the host, backup, recovery, and/or determination of corruption of mass storage data stored at the host. Of course, many variations, modifications, and alternatives are possible without departing from this embodiment.

### FIELD

This disclosure relates to host operating system independent storage-related remote access and operations.

### BACKGROUND

In one conventional arrangement, a host processor in a client executes an operating system. The operating system stores data in a file system at the client. Software agents executed by, in association with, and/or as part of the operating system in the client implement file system utilities. These utilities may implement data backup/recovery, virus detection/repair, and file system repair features. Unfortunately, in this conventional arrangement, as a result of the agents being software processes that rely upon the operating system, the agents themselves and their operations may be relatively easily tampered with by malicious programs (e.g., viruses). Such tampering may render the software agents inoperative and/or may result the co-opting of the agents' functions for use by the malicious programs. Also, these operating system agents do not provide these utilities unless the host processor in the client is executing the operating system agents in a powered-on state. Unfortunately, this may result in the client consuming an undesirably large amount of power to provide the file system utilities. Also unfortunately, this may consume an undesirably large amount of the host processor's processing bandwidth to provide the file system utilities. Additionally, if the operating system or agents have not been properly installed, the utilities may not function properly, if at all.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 illustrates circuitry in an embodiment.

FIG. 3 is a flowchart illustrating operations in an embodiment.

FIG. 4 illustrates processes in an embodiment.

FIG. 5 illustrates operations in an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

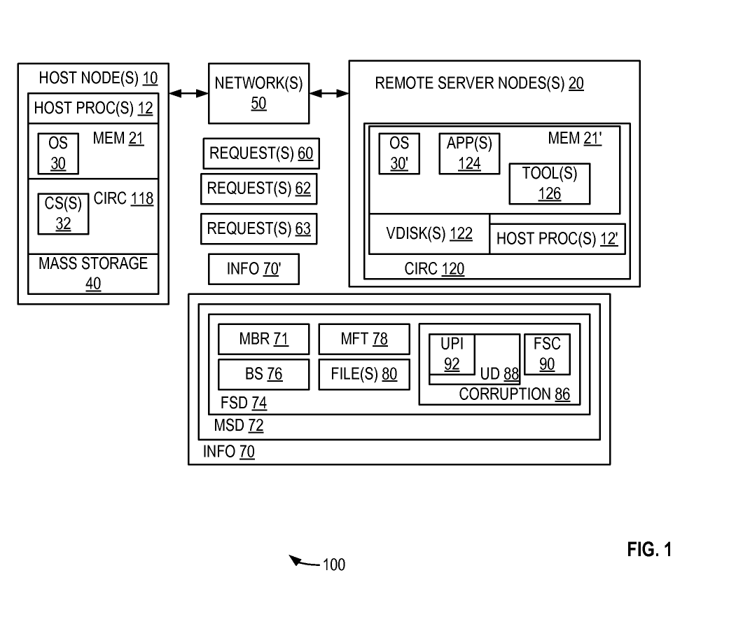

FIG. 1 illustrates a system embodiment 100. System 100 may include one or more host nodes 10 and one or more remote server nodes 20 that may be communicatively coupled together via one or more wireless and/or wired networks 50. In this embodiment, the terms “host node,” “host,” “server,” and “node” may be used interchangeably, and may mean, for example, one or more end stations, appliances, intermediate stations, network interfaces, clients, servers, and/or portions thereof. In this embodiment, a “network” may be or comprise any mechanism, instrumentality, modality, and/or portion thereof that permits, facilitates, and/or allows, at least in part, two or more entities to be communicatively coupled together. Also in this embodiment, a first entity may be “communicatively coupled” to a second entity if the first entity is capable of transmitting to and/or receiving from the second entity one or more commands and/or data. In this embodiment, a “wireless network” means a network that permits, at least in part, at least two entities to be wirelessly communicatively coupled, at least in part. In this embodiment, a “wired network” means a network that permits, at least in part, at least two entities to be communicatively coupled, at least in part, via non-wireless means, at least in part. In this embodiment, data may be or comprise one or more commands, and/or one or more commands may be or comprise data.

One or more hosts 10 may comprise one or more host processors 12, computer-readable/writable memory 21, circuitry 118, and mass storage 40. Circuitry 118 may comprise one or more chipsets (CS) 32. One or more host processors 12 may be communicatively coupled via one or more CS 32 to memory 21 and mass storage 40. Although not shown in the Figures, some or all of circuitry 118, one or more CS 32, memory 21, and/or the functionality and components thereof may be comprised in, for example, one or more host processors 12. Additionally or alternatively, one or more host processors 12, memory 21, and/or some or all of the functionality and/or components thereof may be comprised in, for example, circuitry 118 and/or one or more CS 32. Further alternatively, some or all of circuitry 118, one or more CS 32, and/or the functionality and components thereof may be comprised in, for example, one or more (not shown) circuit cards that may be coupled to one or more system motherboards (not shown). The one or more system motherboards may comprise one or more host processors 12 and at least a portion of memory 21. As used herein, “circuitry” may comprise, for example, singly or in any combination, analog circuitry, digital circuitry, hardwired circuitry, programmable circuitry, co-processor circuitry, state machine circuitry, and/or memory that may comprise program instructions that may be executed by programmable circuitry.

One or more remote server nodes 20 may comprise circuitry 120. Circuitry 120 may comprise one or more host processors 12′, memory 21′, and one or more virtual disks (VDISK) 122.

Each of the one or more host processors 12 and/or 12′ may comprise, for example, a respective Intel® microprocessor commercially available from Intel Corporation. Of course, alternatively, each of the host processors 12 and/or 12′ may comprise a respective microprocessor that is manufactured and/or commercially available from a source other than the Assignee of the subject application.

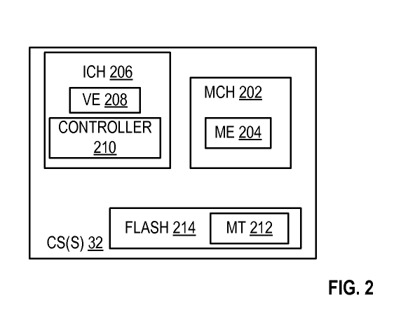

As shown in FIG. 2, one or more CS 32 may comprise memory controller hub (MCH) 202 and input/output (I/O) controller hub (ICH) 206. MCH 202 and ICH 206 may each comprise one or more (not shown) respective integrated circuits, die, and/or chips. MCH 202 may comprise manageability engine (ME) 204. ICH 206 may comprise virtualization engine (VE) 208 and storage protocol controller 210. ME 204 of MCH 202 may be communicatively coupled to VE 208 of ICH 206. VE 208 may be communicatively coupled to controller 210. Controller 210 may be communicatively coupled to mass storage 40. Controller 210 may exchange data and/or commands with mass storage 40 in accordance and/or in a manner compatible with one or more protocols, such as, for example, as described in “Serial ATA: High Speed Serialized AT Attachment,” Revision 1.0, 29 Aug. 2001, by Serial ATA Workgroup (hereinafter “the SATA protocol”), and/or American National Standards Institute (ANSI) Small Computer Systems Interface-2 (SCSI-2) ANSI X3.131-1994 Specification. Also additionally or alternatively, these one or more protocols may be as described in Universal Serial Bus Specification Revision 2.0, published Apr. 27, 2000, copyright 2000, Compaq Computer Corporation, et al., ANSI Standard Fibre Channel (FC) Physical and Signaling Interface-3 X3.303:1998 Specification, and/or “Information Technology—Serial Attached SCSI (SAS),” Working Draft American National Standard of International Committee For Information Technology Standards (INCITS) T10 Technical Committee, Project T10/1562-D, Revision 2b, published 19 Oct. 2002, by ANSI. Further additionally or alternatively, these one or more protocols may be as described in “Information Technology—AT Attachment with Packet Interface-7 (ATA/ATAPI-7),” INCITS T13 Technical Committee, Project 1532D, Revision 4a, published 31 Mar. 2004, by ANSI. Of course, without departing from this embodiment, other and/or additional protocols may be employed, including, for example, later-developed versions and/or variants employing such protocols, such as, for example, external SATA (eSATA).

In this embodiment, ME 204, VE 208, and/or controller 210 may be or comprise one or more respective co-processors. Also in this embodiment, a “processor,” co-processor, and a “controller” each may comprise respective circuitry capable of performing, at least in part, one or more arithmetic and/or logical operations, such as, for example, one or more respective central processing units. Also in this embodiment, a “chipset” may comprise circuitry capable of communicatively coupling, at least in part, one or more host processors, storage, mass storage, one or more nodes, and/or memory. Although not shown in the Figures, circuitry 118 and circuitry 120 also each may comprise a respective graphical user interface system. Each such graphical user interface system may comprise, e.g., a respective keyboard, pointing device, and display system that may permit a human user to input commands to, and monitor the operation of, one or more hosts 10, one or more nodes 20, and/or system 100.

In this embodiment, the terms “storage” and “storage device” may be used interchangeably to mean one or more apparatus into, and/or from which, data may be stored and/or retrieved, respectively. Also in this embodiment, the term “mass storage” may mean storage capable of non-volatile storage of data. As used in this embodiment, “data” may comprise one or more commands and/or one or more instructions. Additionally, in this embodiment, a “virtual disk” may comprise storage and/or mass storage that may store, at least in part, data from other mass storage. In this embodiment, mass storage 40 and/or one or more virtual disks 122 may each include, without limitation, one or more (not shown) respective non-volatile magnetic, optical, and/or semiconductor storage devices.

One or more machine-readable program instructions may be stored in computer-readable/writable memory 21. In operation of one or more hosts 10, these instructions may be accessed and executed by one or more host processors 12, circuitry 118, one or more CS 32 (and/or one or more components thereof, such as, for example, MCH 202, ME 204, ICH 206, VE 208, and/or controller 210). When executed by one or more host processors 12, circuitry 118, one or more CS 32 (and/or one or more components thereof), these one or more instructions may result in one or more host processors 12, circuitry 118, one or more CS 32 (and/or one or more components thereof) performing the operations described herein as being performed by one or more host processors 12, circuitry 118, one or more CS 32 (and/or one or more components thereof).

Likewise, one or more machine-readable program instructions may be stored in computer-readable/writable memory 21′. In operation of one or more remote server nodes 20, these instructions may be accessed and executed by one or more host processors 12′ and/or circuitry 120. When executed by one or more host processors 12′ and/or circuitry 120, these one or more instructions may result in one or more host processors 12′ and/or circuitry 120 performing the operations described herein as being performed by one or more host processors 12′ and/or circuitry 120. Memory 21 and/or memory 21′ each may comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable and/or writable memory.

In this embodiment, one or more hosts 10 and one or more remote server nodes 20 may be geographically remote from each other. Circuitry 118 and/or one or more CS 32 may be capable of exchanging data and/or commands via one or more networks 50 in accordance with one or more protocols. These one or more protocols may be compatible with, e.g., an Ethernet protocol, Transmission Control Protocol/Internet Protocol (TCP/IP), Simple Object Access Protocol (SOAP), Internet Small Computer System Interface (iSCSI) protocol, File Transfer Protocol (FTP), and/or Transport Layer Security (TLS) protocol.

The Ethernet protocol that may be utilized in system 100 may comply or be compatible with the protocol described in Institute of Electrical and Electronics Engineers, Inc. (IEEE) Std. 802.3, 2000 Edition, published on Oct. 20, 2000. The TCP/IP that may be utilized in system 100 may comply or be compatible with the protocols described in Internet Engineering Task Force (IETF) Request For Comments (RFC) 791 and 793, published September 1981. The SOAP that may be utilized in system 100 may comply or be compatible with the protocol described in SOAP Version 1.2 Part 1: Messaging Framework (Second Edition), World Wide Web Consortium (W3C®) Recommendation, published 27 Apr. 2007 by W3C®. The iSCSI protocol that may be utilized in system 100 may comply or be compatible with the protocol described in IETF RFC 5048, published October 2007. The FTP that may be utilized in system 100 may comply or be compatible with the protocol described in IETF RFC 959, published October 1985. The TLS protocol that may be utilized in system 100 may comply or be compatible with the protocol described in IETF RFC 5246, published August 2008. Of course, many different, additional, and/or other protocols may be used for such data and/or command exchange without departing from this embodiment, including for example, later-developed versions of the aforesaid and/or other protocols.

In this embodiment, circuitry 118, one or more CS 32, and/or circuitry 120, as well as the communications and interactions between one or more nodes 10 and one or more nodes 20, generally may be in accordance and/or compatible with Intel® Active Management Technology (AMT). One or more hosts 10 may be or comprise one or more Intel® AMT clients. One or more nodes 20 may be or comprise one or more Intel® AMT remote management servers. Communications between one or more nodes 10 and one or more nodes 20 may take place via one or more Intel® AMT out-of-band channels (not shown) via one or more networks 50.

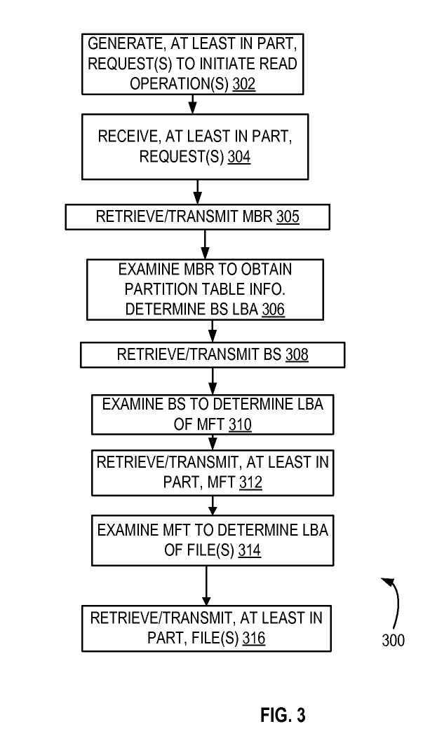

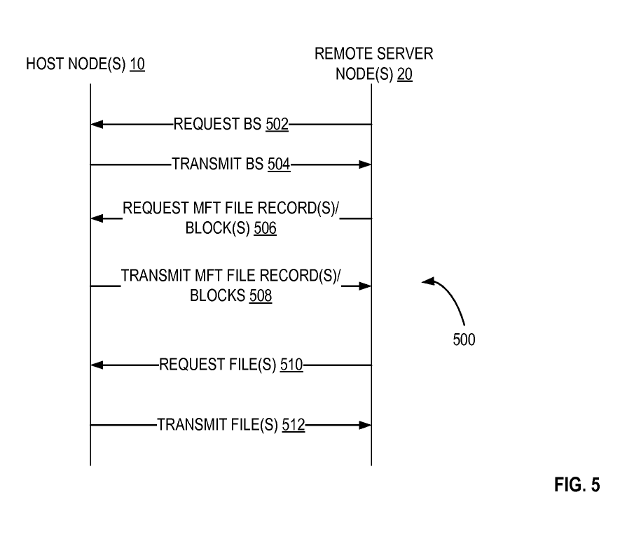

With particular reference now being made to FIGS. 1 to 5, operations 300 (see FIG. 3) and operations 500 (see FIG. 5) that may be performed in system 100 will be described. After, for example, a reset of one or more hosts 10, one or more processors 12 may execute one or more instructions that may result in one or more processors 12 executing one or more operating systems (OS) 30 that may become resident in memory 21. Also after, for example, a reset of one or more nodes 20, one or more host processors 12′ and/or circuitry 120 may execute one or more instructions that may result in one or more processors 12′ and/or circuitry 120 executing one or more OS 30′, one or more backup/recovery/anti-virus applications 124, and/or one or more file system tools 126 that may become resident in memory 21′. In this embodiment, one or more OS 30, OS 30′, applications 124, and/or tools 126 may be or comprise one or more program processes.

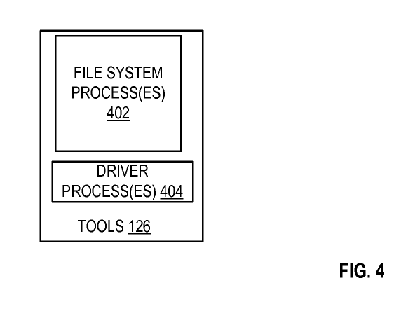

As shown in FIG. 4, tools 126 may comprise one or more file system processes 402 and one or more driver processes 404. One or more file system processes 402 may comprise, for example, one or more virtual file system processes (not shown) and/or one or more Microsoft Corporation Windows® Operating System program processes (not shown). One or more driver processes 404 may be, comprise, and/or operate, at least in part, as one or more interfaces between one or more file system processes 402, one or more OS 30′, one or more applications 124, and/or circuitry 120 of one or more server nodes 20 and circuitry 118, one or more CS 32, ICH 206, MCH 202, ME 204, and/or VE 208 in one or more hosts 10. Thus, for example, in this embodiment, communications, data, and/or commands transmitted from one or more server nodes 20 to one or more hosts 10 may be generated by and/or issued from one or more driver processes 404. Likewise, in this embodiment, communications, data, and/or commands transmitted from one or more host nodes 10 to one or more server nodes 20 may be received by one or more driver processes 404.

A human user (not shown) of one or more nodes 20 may issue via the not shown graphic user interface system one or more commands to one or more OS 30′, one or more applications 124, and/or one or more tools 126. This may result in circuitry 120 generating, at least in part, and issuing, at least in part, one or more requests 60 to one or more hosts 10 via one or more networks 50, as illustrated by operation 302 (see FIG. 3).

As is described below, in this embodiment, one or more requests 60 may request initiation, at least in part, by circuitry 118 of at least one operation at one or more hosts 10. The at least one operation may be to facilitate, at least in part, the examination, remotely from the one or more hosts 10, of information 70 that may be stored at the one or more hosts 10 (e.g., in mass storage 40). Additionally, the at least one operation may be performed at the one or more hosts 10, independently from one or more OS 30 (e.g., out of band with respect to, and without the complicity, involvement, and/or use of one or more OS 30), and also may be performed at least in part by the circuitry 118. The examination of the information 70 may be to facilitate, at least in part, remotely from one or more hosts 10, the backup, recovery, and/or determination of corruption (if any) 86 of mass storage data (MSD) 72 stored in the mass storage 40 at the one or more hosts 10. Such corruption 86 may comprise, for example, unauthorized data (UD) 88 and/or file system corruption (FSC) 90. Such unauthorized data 88 may comprise one or more unauthorized program instructions (UPI, e.g., virus and/or malicious program code) 92 executable, at least in part, by the one or more host processors 12. In this embodiment, “corruption” may include unauthorized and/or undesired data, and/or unauthorized and/or undesired modification in and/or to data.

For example, the one or more commands issued by the human user of one or more nodes 20 may command the backup and/or recovery, at least in part by OS 30′, one or more applications 124, one or more tools 126, and/or one or more virtual disks 122 at one or more nodes 20, of data stored in mass storage 40 at one or more hosts 10. Alternatively or additionally, these one or more commands may command that data stored in mass storage 40 be examined at least in part by OS 30′, one or more applications 124, one or more tools 126, and/or one or more virtual disks 122 at one or nodes 20, to determine corruption that may be present in data stored in the mass storage 40 at the one or more hosts 10. The one or more requests 60 may be for the purpose of initiating, at least in part, at least one operation at the one or more hosts 10 that may be involved, at least in part, in carrying out these one or more commands. For example, one or more requests 60 may be for the purpose of initiating, at least in part, one or more read operations intended to result in retrieval and/or transmission, at least in part, of information 70.

Circuitry 118 may receive, at least in part, via one or more channels (not shown) in one or more networks 50 that may be independent of the one or more OS 30, one or more requests 60, as illustrated by operation 304 (see FIG. 3). In this example, for reasons that are described below, it is assumed that this is the first time that any request or requests of the type of one or more requests 60 have been received, at least in part, by circuitry 118.

In response, at least in part, to one or more requests 60, ME 204 may generate and issue (independently of one or more OS 30) one or more commands to VE 208 and may otherwise initiate, at least in part, one or more operations at one or more hosts 10. These one or more operations may facilitate, at least in part, retrieval of information 70 from mass storage 40, and transmittal of information 70 to circuitry 120 in one or more nodes 20.

More specifically, in response, at least in part, to the one or more commands from ME 204, VE 208 may generate and issue (independently of one or more OS 30) to controller 210 one or more corresponding commands. In response, at least in part, to the one or more commands from VE 208, controller 210 may generate and issue (independently of one or more OS 30) to mass storage 40 one or more commands that may result in the retrieval from mass storage 40 of information 70. Independently of the one or more OS 30, controller 210 may provide the retrieved information 70 to VE 208, and VE 208 may provide the retrieved information 70 to ME 204. ME 204 may transmit (independently of one or more OS 30), at least in part, the retrieved information 70 to circuitry 120.

In this embodiment, information 70 may include master boot record (MBR) 71 obtained from sector zero of mass storage 40. ME 204 may retrieve and/or transmit MBR 71 to circuitry 120 (see operation 305 in FIG. 3), via one or more networks 50, independently of the one or more OS 30. One or more applications 124 and/or one or more file system tools 126 may examine (e.g., parse) the MBR 71 to obtain partition table information that defines one or more active bootable partitions in mass storage 40 (see operation 306 in FIG. 3). Based at least in part upon the partition table information, one or more applications 124 and/or one or more file system tools 126 may determine one or more logical block addresses (LBA) of one or more boot sectors (BS) 76 for these one or more partitions in mass storage 40 (see operation 306 in FIG. 3). One or more requests 60 may request provision of, and information 70 may include, at least in part, one or more BS 76 (see operation 502 in FIG. 5). Accordingly, in response, at least in part to one or more requests 60, independently of one or more OS 30, ME 204 may command retrieval, at least in part, from mass storage 40 of one or more BS 76, and may transmit, at least in part, one or more BS 76 to circuitry 120 (see operation 308 in FIG. 3 and operation 504 in FIG. 5, respectively).

One or more applications 124 and/or one or more tools 126 may examine (e.g., parse) one or more BS 76 to determine one or more logical block addresses of one or more master file tables (MFT) 78 in mass storage 40 (see operation 310 in FIG. 3). The one or more MFT 78 may provide, define, and/or indicate one or more file system directory structures in mass storage 40. One or more requests 60 may request provision of, and information 70 may include, at least in part, one or more MFT 78 (see operation 506 in FIG. 5). Accordingly, in response, at least in part to one or more requests 60, independently of one or more OS 30, ME 204 may command retrieval, at least in part, from mass storage 40 of one or more MFT 78, and may transmit, at least in part, one or more MFT 78 to circuitry 120 (see operation 312 in FIG. 3 and operation 508 in FIG. 5, respectively).

One or more applications 124 and/or one or more tools 126 may examine one or more MFT 78 to determine one or more logical block addresses of one or more files 80 in mass storage 40 (see operation 314 in FIG. 3). One or more requests 60 may request provision of, and information 70 may include, at least in part, one or more files 80 (see operation 510 in FIG. 5). Accordingly, in response, at least in part to one or more requests 60, independently of one or more OS 30, ME 204 may command retrieval, at least in part, from mass storage 40 of one or more files 80, and may transmit, at least in part, one or more files 80 to circuitry 120 (see operation 316 in FIG. 3 and operation 512 in FIG. 5, respectively).

One or more OS 30′, one or more applications 124, and/or one or more tools 126 may mount and store, as a backup or disaster recovery volume, MSD 72 and/or file system data (FSD) 74 in one or more virtual disks 122. As shown in FIG. 1, MSD 72 may comprise FSD 74. FSD 74 may comprise one or more MBR 71, BS 76, MFT 78, and files 80. Thus, in this example, the examination of one or more MBR 71, BS 76, and/or MFT 78 by one or more applications 124 and/or one or more tools 126 may be to facilitate, at least in part, the backup of MSD 72 and/or FSD 74 at node 20.

In this embodiment, one or more OS 30′, one or more applications 124, and/or one or more tools 126 may examine information 70 to determine whether corruption 86 is present in MSD 72 and/or FSD 74. For example, in this embodiment, in order to make this determination, one or more OS 30′, one or more applications 124, and/or one or more tools 126 may examine MBR 71, BS 76, MFT 78, and/or files 80.

Corruption 86 may comprise UD 88 and/or FSC 90 in MSD 72 and/or FSD 74. UD 88 may comprise one or more UPI 92. Although in FIG. 1, for purposes of clarity of illustration, corruption 86 is shown as being separate from one or more MBR 71, BS 76, MFT 78, and files 80, in actual implementation of system 100, depending upon the nature of the corruption 86, the corruption 86 may be comprised at least in part in one or more MBR 71, BS 76, MFT 78, and/or files 80.

If one or more OS 30′, one or more applications 124, and/or one or more tools 126 determines that corruption 86 is present in MSD 72 and/or FSD 74, one or more applications 124, and/or one or more tools 126 in circuitry 120 may generate and issue, at least in part, via one or more networks 50, one or more other requests 62 to circuitry 118. One or more other requests 62 may request that circuitry 118 eliminate and/or correct the corruption 86. In response, at least in part, to one or more requests 62, ME 204 may issue one or more commands to VE 208. In response, at least in part, to the one or more commands, VE 208 may issue one or more others commands to controller 210. This may result in controller 210 issuing to mass storage 40 one or more commands that may result in mass storage 40 eliminating and/or correcting corruption 86. For example, depending upon the nature of the corruption 86, mass storage 40 may remove (e.g., delete) UD 88 and/or one or more UPI 92. Alternatively or additionally, mass storage 40 may repair FSC 90.

After one or more OS 30′, one or more applications 124, and/or one or more tools 126 have stored a backup or disaster recovery volume of MSD 72 and/or file system data (FSD) 74 in one or more virtual disks 122, ME 204, VE 208, and/or controller 210 may maintain in flash memory 214 in one or more CS 32 one or more modification tables (MT) 212. Flash memory 214 may be hidden from and inaccessible to the one or more OS 30 and one or more host processors 12. One or more MT 212 may indicate, at least in part, changes to the MFT 78 that may have occurred since the last backing up of MSD 72 and/or FSD 74 at one or more nodes 20. After the backing up of the MSD 72 and/or FSD 74, one or more OS 30′, one or more applications 124, and/or one or more tools 126 may generate and issue, at least in part, one or more additional requests 63 to circuitry 118. In response, at least in part, to one or more requests 63, ME 204 may issue (independently of one or more OS 30) to circuitry 120 via one or more networks 50, as part of information 70′, one or more MT 212, at least in part. One or more applications 124 and/or one or more tools 126 may examine one or more MT 212 to determine changes (if any) to one or more MFT 78 and/or files 80 that may have occurred since the last backing up of MSD 72 and/or FSD 74 at one or more nodes 20. One or more requests 63 may request provision of, and information 70′ may include changes that have occurred to one or more files 80 since the last backing up of MSD 72 and/or FSD 74. Accordingly, in response, at least in part to one or more requests 63, independently of one or more OS 30, ME 204 may transmit to circuitry 120, as information 70′ and/or MSD 72, solely one or more MT 212 and these changes that have occurred to one or more files 80. One or more OS 30′, one or more applications 124, and/or one or more tools 126 then may perform an incremental backup and/or examination for corruption based only upon information 70′. Advantageously, this may reduce the amount of traffic, time, and/or bandwidth consumed in system 100 to mount and store incremental backups of MSD 72 and/or FSD 74 in one or more virtual disks 122.

After MSD 72 and/or FSD 74 has been backed up in one or more virtual disks 122, in the event that it is desired to perform a recovery of MSD 72 and/or FSD 74 to mass storage 40, one or more OS 30′, one or more applications 124, and/or one or more tools 126 may transmit the backup copy of MSD 72 and/or FSD 74 to ME 204. ME 204 may issue (independently of one or more operating systems 30) commands to VE 208 that may result in VE 208 issuing (independently of one or more operating systems 30) other commands to controller 210. This may result in controller 210 (independently of one or more operating systems 30) storing in mass storage 40 a copy of the backup copy of MSD 72 and/or FSD 74.

In this embodiment, one or more CS 32, MCH 202, ME 204, ICH 206, VE 208, and/or controller 210 may be capable of executing the operations described herein as being performed by one or more CS 32, MCH 202, ME 204, ICH 206, VE 208, and/or controller 210 independently of one or more OS 30 and the power state or condition of one or more host processors 12. Thus, for example, one or more CS 32, MCH 202, ME 204, ICH 206, VE 208, and/or controller 210 are capable of performing these operations regardless of whether the one or more OS 30 and/or one or more host processors 12 are operational and/or in a fully powered-on state. Advantageously, this may permit this embodiment to operate regardless of whether the one or more operating systems 30 and/or host processors 12 are operating properly. Also advantageously, this may permit this embodiment to operate as described above even when the one or more host processors 12 are in a relatively lower power state such, as for example, a powered-down, sleep, or hibernation state, relative to a fully powered-on state of the one or more host processors 12, thereby permitting this embodiment to consume less power in carrying out such operations.

Also in this embodiment, communication between the circuitry 118 and the circuitry 120 may be carried out in accordance with secure hardware-based authentication techniques (e.g., in accordance with Intel® AMT hardware authentication and out-of-band communication channels). Advantageously, this may permit this embodiment to exhibit improved, hardened authentication and security properties.

As stored in mass storage 40 and/or one or more virtual disks 122, and/or as transmitted via one or more networks 50, information 70, MSD 72, FSD 74, and/or one or more portions thereof may be encrypted. Circuitry 118 and/or circuitry 120 may be capable of encrypting and decrypting information 70, MSD 72, FSD 74, and/or one or more portions thereof in order to be able to carry out the operations described herein as being carried out by circuitry 118 and/or circuitry 120.

In this embodiment, “encryption” and/or “encrypting” may comprise one or more operations comprised in, facilitating, and/or resulting in, at least in part, generation of cipher text from plaintext. Also in this embodiment, “decryption” and/or “decrypting” may comprise one or more operations comprised in, facilitating, and/or resulting in, at least in part, generation of plaintext from cipher text. In this embodiment, “plaintext” may include data that is, at least in part, encrypted and/or has already undergone and/or is presently undergoing encryption and/or decryption. In this embodiment, an “instruction” may include data and/or one or more commands.

Thus, an embodiment may include circuitry that may be comprised in a host that may execute an operating system and/or a server. The circuitry may generate, at least in part, and/or receive, at least in part, at least one request to initiate, at least in part, at least one operation at the host. The at least one operation may facilitate, at least in part, examination remotely from the host of information stored at the host. The at least one operation may be performed independently from the operating system and also may be performed at least in part by the circuitry. The examination may facilitate, at least in part, remotely from the host, backup, recovery, and/or determination of corruption of mass storage data stored at the host. Of course, many variations, modifications, and alternatives are possible without departing from this embodiment.

In addition to the other advantages of this embodiment, the above operations of circuitry 118 do not rely upon agent software processes and/or one or more operating systems 30. This makes it more difficult for circuitry 118 to be tampered with and/or its operations co-opted by malicious programs (e.g., viruses). Many other advantages will be apparent to those skilled in the art.

Many variations, alternatives, and modifications are possible without departing from this embodiment. For example, although it has been described above that one or more remote servers 20 may initiate operations 300 and/or operations 500 (e.g., by generating at least in part one or more requests 60), alternatively, without departing from this embodiment, one or more host nodes 10 instead may initiate operations 300 and/or operations 500, at least in part. Of course, many other and/or additional variations, alternatives, and modifications will be apparent to those skilled in the art. The accompanying claims are intended to encompass all such variations, alternatives, and modifications.

What is claimed is:

1. An apparatus comprising:
circuitry to be comprised in at least one of a server and a host, the host being to execute an operating system, the circuitry being to at least one of generate, at least in part, and receive, at least in part, at least one request, the at least one request being to initiate, at least in part, at least one operation at the host, the at least one operation being to facilitate, at least in part, examination remotely from the host of information stored at the host, the at least one operation being performed independently from the operating system and being performed at least in part by the circuitry, the examination being to facilitate, at least in part, remotely from the host at least one of backup, recovery, and determination of corruption of mass storage data stored at the host.

2. The apparatus of claim 1, wherein:
the information comprises file system data related, at least in part, to the mass storage data;
the corruption comprises at least one of unauthorized data and file system corruption; and
the circuitry is to, in response at least in part to at least one other request, at least one of remove the unauthorized data and repair the file system corruption.

3. The apparatus of claim 2, wherein:
the information also comprises the unauthorized data;
the host comprises a host processor to execute the operating system; and
the unauthorized data comprises at least one unauthorized program instruction executable by the host processor.

4. The apparatus of claim 3, wherein:
the server is remote from the host and is to issue, at least in part, the at least one request and the at least one other request to the circuitry; and
the host is to transmit, at least in part, the mass storage data to the server in accordance with a transport layer security protocol.

5. The apparatus of claim 1, wherein:
the information indicates, at least in part, one or more portions of the mass storage data that have been modified, at least in part, since backing up of the mass storage data at the server, the server being remote from the host.

6. The apparatus of claim 1, wherein:
the at least one operation includes a plurality of operations, the operations including:
transmission, at least in part, from the circuitry to the server, of a boot sector retrieved at least in part by the circuitry from mass storage, the server being remote from the host;
transmission, at least in part, from the circuitry to the server, of a master file table retrieved, at least in part, by the circuitry, from at least one location in the mass storage, the at least one location being determined by the server based at least in part upon the boot sector; and
transmission, at least in part, from the circuitry to the server, of at least one file corresponding, at least in part, to the mass storage data, the at least one file being determined by the server based at least in part upon the master file table.

7. A method carried out at least in part by circuitry, the method comprising:
at least one of generating, at least in part, and receiving, at least in part, at least one request, the at least one request being to initiate, at least in part, at least one operation at a host, the circuitry to be comprised in at least one of a server and the host, the host being to execute an operating system, the at least one operation being to facilitate, at least in part, examination remotely from the host of information stored at the host, the at least one operation being performed independently from the operating system and being performed at least in part by the circuitry, the examination being to facilitate, at least in part, remotely from the host at least one of backup, recovery, and determination of corruption of mass storage data stored at the host.

8. The method of claim 7, wherein:
the information comprises file system data related, at least in part, to the mass storage data;
the corruption comprises at least one of unauthorized data and file system corruption; and
the method also comprises, in response at least in part to at least one other request, at least one of removing the unauthorized data and repairing the file system corruption.

9. The method of claim 8, wherein:
the information also comprises the unauthorized data;
the host comprises a host processor to execute the operating system; and
the unauthorized data comprises at least one unauthorized program instruction executable by the host processor.

10. The method of claim 9, wherein:
the server is remote from the host and is to issue, at least in part, the at least one request and the at least one other request to the circuitry; and
the host is to transmit, at least in part, the mass storage data to the server in accordance with a transport layer security protocol.

11. The method of claim 7, wherein:
the information indicates, at least in part, one or more portions of the mass storage data that have been modified, at least in part, since backing up of the mass storage data at the server, the server being remote from the host.

12. The method of claim 7, wherein:
the at least one operation includes a plurality of operations, the operations including:
transmission, at least in part, from the circuitry to the server, of a boot sector retrieved at least in part by the circuitry from mass storage, the server being remote from the host;
transmission, at least in part, from the circuitry to the server, of a master file table retrieved, at least in part, by the circuitry, from at least one location in the mass storage, the at least one location being determined by the server based at least in part upon the boot sector; and
transmission, at least in part, from the circuitry to the server, of at least one file corresponding, at least in part, to the mass storage data, the at least one file being determined by the server based at least in part upon the master file table.

13. Computer-readable memory storing one or more instructions that when executed by a machine result in execution of a set of operations comprising:
at least one of generating, at least in part, and receiving, at least in part, by circuitry at least one request, the at least one request being to initiate, at least in part, at least one operation at a host, the circuitry to be comprised in at least one of a server and the host, the host being to execute an operating system, the at least one operation being to facilitate, at least in part, examination remotely from the host of information stored at the host, the at least one operation being performed independently from the operating system and being performed at least in part by the circuitry, the examination being to facilitate, at least in part, remotely from the host at least one of backup, recovery, and determination of corruption of mass storage data stored at the host.

14. The memory of claim 13, wherein:
the information comprises file system data related, at least in part, to the mass storage data;
the corruption comprises at least one of unauthorized data and file system corruption; and
the set of operations also comprises, in response at least in part to at least one other request, at least one of removing the unauthorized data and repairing the file system corruption.

15. The memory of claim 14, wherein:
the information also comprises the unauthorized data;
the host comprises a host processor to execute the operating system; and
the unauthorized data comprises at least one unauthorized program instruction executable by the host processor.

16. The memory of claim 15, wherein:
the server is remote from the host and is to issue, at least in part, the at least one request and the at least one other request to the circuitry; and
the host is to transmit, at least in part, the mass storage data to the server in accordance with a transport layer security protocol.

17. The memory of claim 13, wherein:
the information indicates, at least in part, one or more portions of the mass storage data that have been modified, at least in part, since backing up of the mass storage data at the server, the server being remote from the host.

18. The memory of claim 17, wherein:
the at least one operation includes a plurality of operations, the plurality of operations including:
transmission, at least in part, from the circuitry to the server, of a boot sector retrieved at least in part by the circuitry from mass storage, the server being remote from the host;
transmission, at least in part, from the circuitry to the server, of a master file table retrieved, at least in part, by the circuitry, from at least one location in the mass storage, the at least one location being determined by the server based at least in part upon the boot sector; and
transmission, at least in part, from the circuitry to the server, of at least one file corresponding, at least in part, to the mass storage data, the at least one file being determined by the server based at least in part upon the master file table.

19. The apparatus of claim 1, wherein:
the host comprises a host processor to execute the operating system;
the circuitry is to perform, at least in part, the at least one operation while the host processor is in a relatively lower power state relative to a fully powered-on state;
the at least one operation comprises at least one read operation of the mass storage data, the mass storage data being stored at least in part in mass storage at the host; and
the circuitry is to provide, at least in part, the mass storage data to the server, the server being remote from the host.

20. The memory of claim 13, wherein:
the host comprises a host processor to execute the operating system;
the circuitry is to perform, at least in part, the at least one operation while the host processor is in a relatively lower power state relative to a fully powered-on state;
the at least one operation comprises at least one read operation of the mass storage data, the mass storage data being stored at least in part in mass storage at the host; and
the circuitry is to provide, at least in part, the mass storage data to the server, the server being remote from the host.
